(19) United States
(12) Patent Application Publication
(10) Pub. No.: US 2026/0054706 A1
(43) Pub. Date: Feb. 26, 2026

(54) BRAKING DEVICE FOR A VEHICLE WITH INCREASED OPERATING SAFETY AND METHOD FOR OPERATION

(71) Applicant: Continental Automotive Technologies GmbH, Hannover (DE)

(72) Inventors: Joseph Dolmaya, Langen (DE); Georg Sonnenschein, Dreieich (DE); Marco Müller, Lahnau (DE); Christian Courth, Frankfurt (DE); Johannes Görlach, Langgöns (DE)

(73) Assignee: Continental Automotive Technologies GmbH, Hannover (DE)

(21) Appl. No.: 19/104,952

(22) PCT Filed: Aug. 9, 2023
(86) PCT No.: PCT/DE2023/200160

§ 371 Date: Feb. 19, 2025

(30) Foreign Application Priority Data
Aug. 19, 2022 (DE) 10 2022 208 623.6

(51) Int. Cl. B60T 13/66; B60T 8/171; B60T 8/172; B60T 13/14; B60T 13/68; B60T 13/74

(52) U.S. Cl. CPC B60T 13/662; B60T 8/171; B60T 8/172; B60T 13/148; B60T 13/686; B60T 13/745; B60T 2270/88

(57) ABSTRACT

A braking device for a vehicle with increased operating safety and to a method for operating a braking device for a vehicle with increased operating safety is described. The proposed braking device comprises a container with a cavity, a hydraulic block and an electronic brake control device that is configured to control the pressure supply device. The brake control device is arranged in the container. Furthermore, at least one sensor element that is designed to detect a fluid is provided.

### TECHNICAL FIELD

A braking device for a vehicle with increased operating safety and a method for operating a braking device for a vehicle with increased operating safety is disclosed.

### BACKGROUND

Service brake systems for motor vehicles are generally known, in which the wheels on the front or rear axle can be braked by means of electro-hydraulically or hydraulically actuatable wheel brakes.

An electro-hydraulic brake system may have for this purpose, for example, a hydraulic block, wherein an electromotive pressure supply device, which is connected to a brake fluid reservoir and the hydraulically actuated wheel brakes, is arranged, inter alia, in the hydraulic block. For a compact design and easy installation, the required components, for example the pressure supply device and the associated electronic brake control device, can be accommodated in a common module.

A braking request from the vehicle driver is typically detected by a corresponding actuation apparatus with a brake pedal that is designed to determine an actuation signal quantifying a braking request as a result of actuation by a vehicle driver and to pass it on to the brake control device.

In the case of hydraulically actuatable service brake systems, for example, a reaction to the brake pedal can take place when the brake is actuated, such that the vehicle driver can be provided with a brake pedal sensation which depends on the brake pressures at the wheel brakes. In this way, the vehicle driver is in contact with the wheel brakes during normal operation.

If, on the other hand, an electric brake pedal, also referred to as an e-pedal, is used as an actuation apparatus, a reaction to the brake pedal in the event of a change in pressure is no longer possible via the mechanical or hydraulic connection between the brake pedal and the wheel brake. This can be unfavorable if there are impairments in connection with the service brake, for example as a result of a leak in the area of the brake fluid system.

A leak in the brake fluid system can be detected by means of a brake fluid switch. However, it may also be possible that brake fluid does not leak out of the brake system, but accumulates inside the braking device. This can also allow brake fluid to enter the module or to reach or enter the associated components. For example, in the worst case leaking brake fluid can come into contact with the brake control device, which can affect the control of the wheel brake.

If a loss of brake fluid is now reported to the vehicle driver and as a result this possible deficit of brake fluid is simply replenished, this does not eliminate the problem that brake fluid that has leaked inside the braking device can cause damage. In other words, a leak that takes place inside the braking device cannot be reliably detected in this way in certain cases.

Especially when an electric brake pedal is used, the vehicle driver also cannot receive any feedback about possible impairments to the functionality of the braking device via the brake pedal in these cases. As a result, the vehicle driver no longer has a direct possible way of detecting changes in connection with the service brake system, for example as a result of a leak in the brake fluid reservoir. As a result, the vehicle driver is also no longer able to detect a possible deterioration of the brake system or is not able to detect it sufficiently quickly.

This can be problematic insofar as such a leak within the braking device could lead to impairment of the braking capacity, which is not detected.

Therefore, specifying a braking device for a motor vehicle, and a method for operating such a braking device, which has increased operating safety is desireable.

### SUMMARY

A braking device as part of a brake system for a motor vehicle and a method for operating a braking device are disclosed.

A a first aspect to a braking device as part of a brake system, in particular for a motor vehicle, comprises
a container with a cavity,
a hydraulic block with a pressure supply device, and
an electronic brake control device which is configured to control the pressure supply device,
wherein the electronic brake control device is arranged in the container,
wherein at least one sensor element that is designed to detect a fluid is provided, and
wherein the sensor element is arranged in the container or in the hydraulic block.

The braking device may be part of a service brake, in particular for a motor vehicle.

The container may be of closed design for the protection of the electronic brake control device and in this way defines a cavity. The brake control device is at least partially or completely arranged in the cavity of the container.

The pressure supply device may also be arranged in this container. In one embodiment, provision is therefore made for the pressure supply device to be accommodated in a so-called hydraulic block and for the electronic brake control device to be accommodated in a container separate therefrom, wherein the container and the hydraulic block can be firmly connected to one another.

The container for the electronic brake control device may be fitted on the side next to the hydraulic block, but may also be fitted underneath it, for example for reasons of space. The hydraulic block and the container with the electronic brake control device, and possibly further devices, for instance an associated brake fluid reservoir, can be formed and provided together as a module according to one embodiment.

Regardless of this, further devices and components for a brake or a wheel brake may also be accommodated in the container.

At least one sensor element is designed to detect a fluid is provided in the container. The at least one sensor element may be arranged at a location within the container or the hydraulic block pointing to the base during operation in order to be able to detect infiltrating fluid as early as possible.

The braking device may comprise a switching unit for processing signals from the at least one sensor element. However, the switching unit may also be formed as part of the brake control device or may be integrated in the brake control device. The brake control device or the switching unit may also comprise at least one storage unit in order to store measured values from the sensor element, for example. The sensor element is connected to the electronic brake control device or to the switching unit, such that the sensor element can be supplied with current and controlled and the switching unit or the brake control device can receive signals from the sensor.

The fluid may generally comprise a liquid medium. This should be understood as brake fluid, oil, water, coolant, steering fluid or other fluids that may occur or may be present in connection with the operation of a vehicle.

The sensor element is designed to identify or detect the presence or occurrence of a fluid. In other words, the sensor element can detect a fluid and generate a signal that can be transmitted to the electronic brake control device or the switching unit when the sensor element comes into contact with the fluid. The sensor signal can be queried or the sensor element monitored either cyclically or continuously. Suitable controllers may be provided for this.

According to one embodiment, the container or the hydraulic block may comprise a base or a base area, with a recess, which, in the mounted position, for example in the operating state of the braking device, defines the lowest point of the container. The base can be designed to taper at an angle toward the recess. Compared to a rather flat base area, this can ensure that a fluid in the container collects at a defined location in the recess. A fluid in the container can thus be detected reliably and quickly. Nesting or twisting in the base area should be avoided wherever possible, as this could impair the flow of the fluid toward the recess, with the result that infiltrating fluid may not be detected in time.

In one development, at least one bead which is oriented toward the recess may be additionally provided in the base. This allows a fluid to be quickly directed to the recess where it can be detected.

In principle, it is not desirable for a fluid to be located in the container or in the hydraulic block during operation, since, in the event of contact between a fluid and the electronic brake control device, which is typically in the form of a printed circuit board or can comprise a printed circuit board, impairments and/or damage to the brake control device can occur. For example, electronic component parts may be damaged, which may impair the functionality of the brake. Corrosion can also occur.

The fluid can enter the container with the brake control device from the outside, for instance fluid from the environment due to a leak of the container. However, the fluid can also leak from the hydraulic block and enter the container, for example if the pressure supply device has a leak. The hydraulic block may comprise, for example, valves from which fluid, in particular brake fluid, can also leak. For example, brake fluid can enter the container with the electronic brake control device in this manner.

The at least one sensor element may be arranged in the base area or near the base of the container or the hydraulic block in order to be able to detect a possible fluid quickly. The at least one sensor element may be arranged in the area of the recess or even, if possible due to the installation space, arranged within the recess in order to be able to detect a fluid.

Instead of a single sensor element, which thus represents a discrete measurement point, according to one development, a plurality of sensor elements can also be provided and can be at a distance from one another in the vertical direction. This makes it possible to provide a plurality of discrete measurement points which can detect different heights or filling levels of fluid in the container or the hydraulic block.

In one embodiment, the container is of two-part design, wherein an intermediate wall separates a first and a second partial volume from each other. A part of the cavity of the container is therefore defined as a partial volume. The two-part design makes it possible to provide the brake control device in two ways, with the result that these components, which are important for the functioning of the brake, are present in two ways and there is thus redundancy.

For this purpose, a first electronic brake control device may be arranged in the first partial volume and a second electronic brake control device may be arranged in the second partial volume.

During normal operation, for example, the wheel brake can then be operated by means of the first electronic brake control device in the first partial volume. In case of impairment or failure of the first brake control device in the first partial volume, it is then possible to switch to the second brake control device in the second partial volume. For this purpose, the intermediate wall may be fluid-tight, as far as technically possible, so that the second partial volume of the container is protected from infiltration of fluid into the first partial volume.

According to one embodiment, the brake control device comprises at least one printed circuit board (PCB), wherein the sensor element is formed on the printed circuit board or as part of the printed circuit board. This enables production and assembly.

The at least one sensor element may be arranged on a section of the printed circuit board pointing to the base during operation. In one embodiment, this section of the printed circuit board pointing to the base during operation is free of other electronic or other component parts, with the result that the sensor element during normal operation is virtually the lowest lying component part of the printed circuit board. The section pointing to the base thus means an area of the printed circuit board that adjoins the lower edge of the edge of the printed circuit board pointing to the base. In this way, an ingress of fluid can already be detected by the sensor element before other component parts can come into contact with ingressing fluid.

According to one development, the printed circuit board may also comprise a projecting area or projection on the edge pointing to the base during operation. The at least one sensor element may then be placed on this projection. The surface area of the printed circuit board can be used in this way for the required component parts, and layout plans can be adopted without major changes or need not be changed in order to be able to place the sensor element.

The projection may be geometrically or structurally adapted to the recess in the base area of the container. This makes it possible to arrange the projection with the sensor element at least in sections in the recess.

However, the sensor element may also be formed as a separate component part according to a further embodiment. This allows greater flexibility with respect to the arrangement of the recess and the printed circuit board.

In one embodiment, the at least one sensor element is in the form of a conductivity sensor. For this purpose, according to one embodiment, two conductor tracks may be arranged on the printed circuit board at a short distance from each other, for example one or a few millimeters, with which electrical contact is made and to which an electrical voltage is applied. In the event of contact with the fluid, an electrical connection can be established between the two conductors and an electrical short circuit can be generated, which can be detected by the switching unit or the brake control device. In other words, the electrical contact of the two conductors is electrically isolated from each other by an isolation section, wherein this isolation section can be bridged by the fluid. A measured value of an electrical variable resulting between the electrical contacts can be recorded.

In the case of at least one sensor element or one discrete measurement point, the switching unit can thus receive a signal or information indicating that a fluid is present at the measurement point. This may indicate, for example, that brake fluid has entered the recess of the container or the hydraulic block. In the case of a plurality of sensor elements or a plurality of discrete measurement points, information about the height of the filling level of fluid can also be obtained. In this way, a leakage rate can also be determined, for instance.

The switching unit or the electronic brake control device may be configured to process this information and to initiate corresponding actions based on stored fault data or protocols and by means of a decision logic. These may include, for example, warnings to the vehicle driver. Accordingly, a device for generating and outputting information or a warning to the vehicle driver may also be included.

For example, warning lights in the vehicle driver's field of view may light up yellow or red in order to indicate the hazard and degree of impairment.

This ensures that, in the event of a sudden leak, for example due to a leak of a sealing ring due to wear or material fatigue, this is quickly detected and corresponding countermeasures can be initiated.

In one development, provision is also made to influence the open-loop control and closed-loop control of the brake system. This can be effected, for example, by virtue of the fact that, instead of the first brake control device which may be impaired by the infiltration of fluid into the first partial volume, the second brake control device is activated and is thus used to control the wheel brake. At this point, it should be noted that no distinction is made between the terms open-loop control and “closed-loop control within the context of the present embodiments. The meaning of the corresponding terms is clear from the respective context.

In one development, it is also envisaged to end the driving mode according to a predefined program if a critical value is undershot or exceeded, for example in an autonomous driving mode.

In this way, a fallback level can be created in the event of a leak in the braking device, for example a leaking pressure supply device.

For this purpose, it may already be sufficient if, in the case of a two-part design of the container, the at least one sensor element is arranged solely in the first partial volume in which the brake control device for normal operation is accommodated. If a fluid is detected in this partial volume, it is possible to switch to the brake control device in the second partial volume, and operation of the wheel brake in a fallback level as emergency operation can be maintained.

Since the intermediate wall, which separates the two partial volumes from each other, often cannot be designed to be fluid-tight, for example as a result of wiring through the intermediate wall, according to one embodiment, provision is made for a sensor element to be arranged in each case in the first and the second partial volume. In this way, information about infiltrating fluid can be generated in both partial volumes. Therefore, the fluid can also infiltrate both partial volumes simultaneously and thus the functionality of the braking device can still be monitored.

If, for example, sensor elements detect fluid infiltration in both partial volumes, a red warning light can signal to the vehicle driver that the braking device is defective and that it is not possible to continue driving. This makes it possible to ensure a further increase in safety, also with regard to partially automated or fully automated driving.

The above-mentioned conductivity sensor represents only one possible embodiment of a sensor element. Other embodiments of the sensor element are also envisaged and provided.

According to a further, embodiment, a sensor element comprising a fluid-sensitive element is provided. The fluid-sensitive element may comprise a material which, in conjunction with fluid, changes at least one property, for example the volume or the electrical conductivity.

In a first design of this embodiment, provision is made for the element to comprise a material which expands upon contact with the fluid and thus increases its volume. The expansion can exert a force on a pressure sensor, which can be detected. The change in volume can thus be detected by means of the pressure sensor, which can then send a corresponding signal to the switching unit. The swelling material may include a hydrophilic polymer material, such as rubber.

In a second design, provision is made for the element to comprise a material which shrinks or even dissolves due to contact with the fluid. For this purpose, a material which is electrically conductive may be selected. This material can be arranged between two electrical conductors. If this material shrinks or even dissolves upon contact with the fluid, the electrical connection is interrupted and the switching unit receives a corresponding signal. A suitable material may include a thermoplastic material, in particular polyvinyl alcohol (PVA), which can dissolve upon contact with fluid. This effect can be used to interrupt an electrical contact.

In another development, a hygroscopic material is also provided, which can absorb a fluid upon contact with the latter and can thereby change its properties, for example its electrical conductivity. The electrical resistance can be continuously measured by means of the brake control device, with the result that a change in the electrical conductivity can be detected and in this way an incoming fluid can be detected.

According to a further, embodiment, a sensor element comprising a float is provided, wherein the float is movably arranged in the vertical direction. When a certain position is reached or when a predefined position is left, a corresponding electrical signal can be sent to the switching unit, for example by the float triggering a microswitch at a certain position. The use of reed switches or reed sensors in combination with permanent magnets is also envisaged and possible. For example, the float can be arranged in the hydraulic block.

According to a further, embodiment, a sensor element which is in the form of an optical liquid sensor is provided, comprising an emitter which can emit electromagnetic radiation, and a light sensor which is designed to detect this electromagnetic radiation. The emitter may comprise, for example, a light-emitting diode or a laser source. For example, the light sensor may comprise CMOS or CCD sensors.

In a first design of this embodiment, provision is made for the emitter to emit the electromagnetic radiation directly in the direction of the light sensor. In other words, the light sensor is in the main beam direction of the emitter. The emitter and the light sensor may be arranged at a certain distance from each other, such that fluid can pass between the emitter and the light sensor.

When a fluid infiltrates the space between the emitter and the light sensor, the electromagnetic radiation can be attenuated by optical effects, for example by light scattering. This attenuation can be detected by the light sensor and sent as a corresponding signal to the switching unit.

However, it is also possible to arrange the emitter in the first partial volume, for example on a printed circuit board of the first electronic brake control device, and to arrange the light sensor in the second partial volume, for example on the second printed circuit board of the second electronic brake control device, and to pass the radiation through a continuous opening through the hydraulic block.

A through-hole, for example, which serves for the wiring of the two electronic brake control devices, can be used for this purpose. In this way, it is not necessary to respectively arrange an emitter and a sensor element in each of the two partial volumes. It goes without saying that the emitter, light sensor and continuous opening are arranged as close to the base as possible. If the through-hole is designed appropriately, a fluid leaking from the hydraulic block can be detected very quickly, for example before the printed circuit boards can be damaged.

In a further design of this embodiment, provision is made for the emitter to direct the electromagnetic radiation in the direction of a reflective element, for example a mirror. During normal operation, this reflective element can reflect the incident radiation and deflect it in the direction of the light sensor. For this purpose, the reflective element is advantageously inclined with respect to the beam direction of the emitter. The mirror can be very small, such that it can be arranged without problems on the base of the container or, if present, in the recess. According to a further embodiment, the recess may also have a reflective surface which in this respect represents the reflective element. As soon as fluid infiltrates, at least part of the electromagnetic radiation is diffusely reflected at the surface of the fluid, with the result that an attenuation also occurs at the light sensor and can be detected. This design can also be implemented in a cost-effective manner and is highly flexible, since the reflective element can be arranged without contacts at the lowest point of the container.

In a further aspect, a method for operating a brake system for vehicles, in particular a service brake system, comprising at least one braking device as explained above is also described.

In another aspect, the embodiments also include a brake system, in particular a service brake system, for a vehicle, comprising at least one braking device as explained above. The brake system can be used to control a wheel or to control the wheels of an axle or for all wheels.

The present embodiments thus provides a braking device, in particular for a motor vehicle, and a method for operating such a brake system that has increased operating safety.

Thus, the embodiments also provide a brake system for the partially automated or automated driving mode, for example level 2 according to SAE J3016 or above.

Further details are clear from the description of the illustrated exemplary embodiments and the attached claims.

### BRIEF DESCRIPTION OF THE DRAWINGS

### In the Drawings:

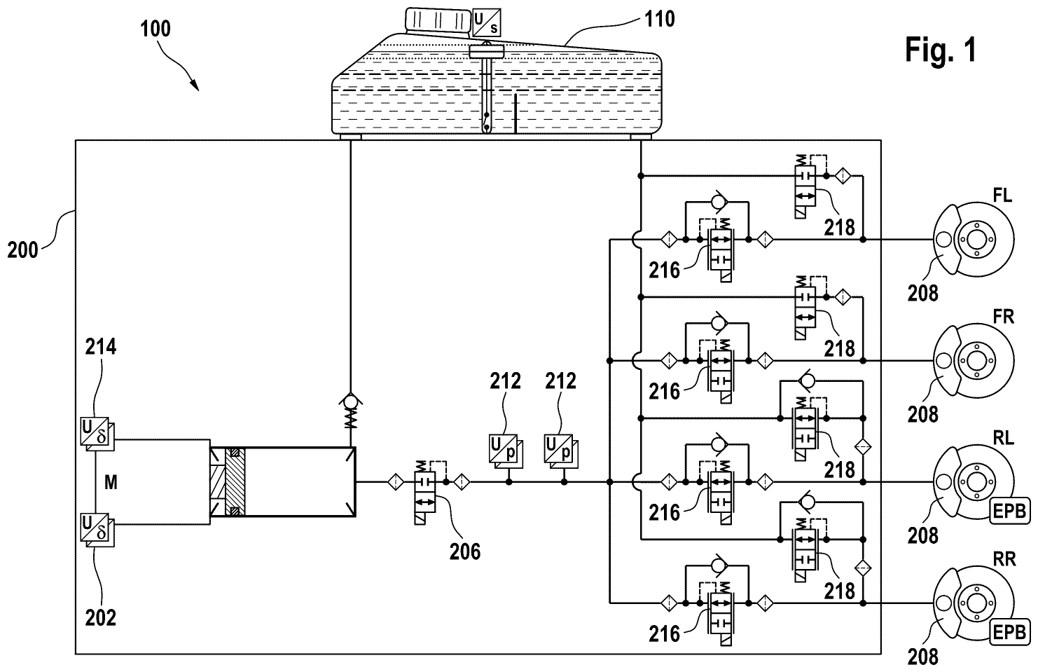

FIG. 1 shows a schematic representation of a circuit diagram of an exemplary braking device,

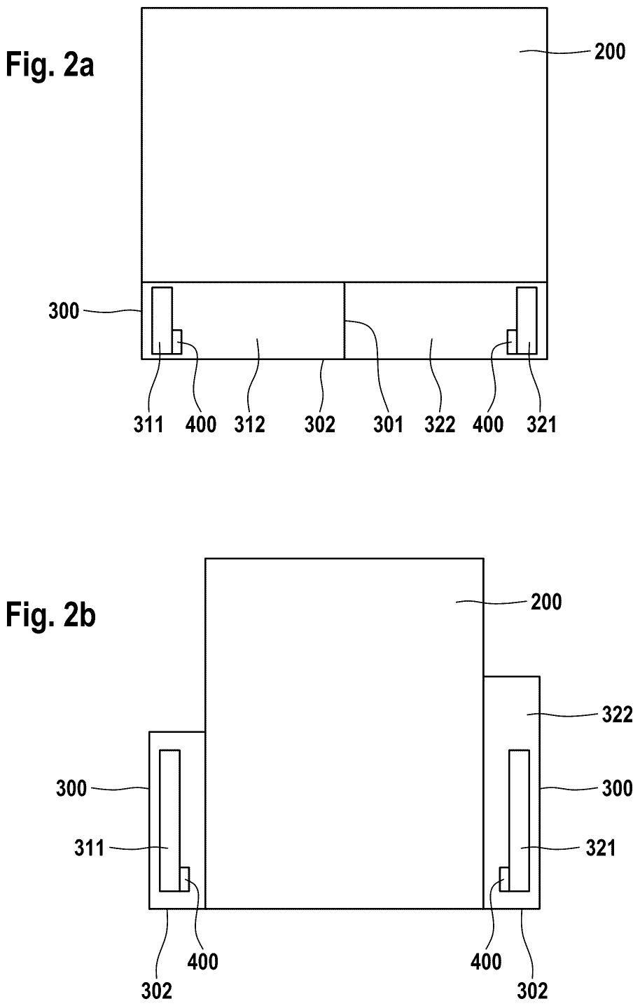

FIG. 2a shows a schematic representation of an exemplary braking device with a possible arrangement of a hydraulic block and a container for accommodating an electronic brake control device,

FIG. 2b shows a schematic representation of an exemplary braking device with a further possible arrangement of a hydraulic block and a container for accommodating an electronic brake control device,

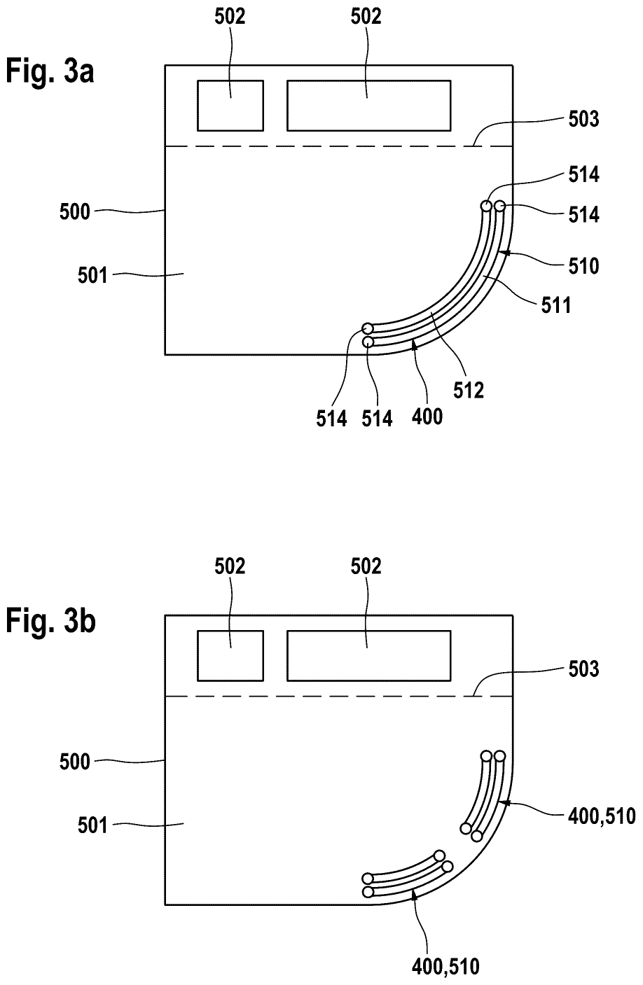

FIG. 3a shows a schematic representation of a section of a printed circuit board with a conductivity sensor,

FIG. 3b shows a schematic representation of a section of a printed circuit board with two conductivity sensors,

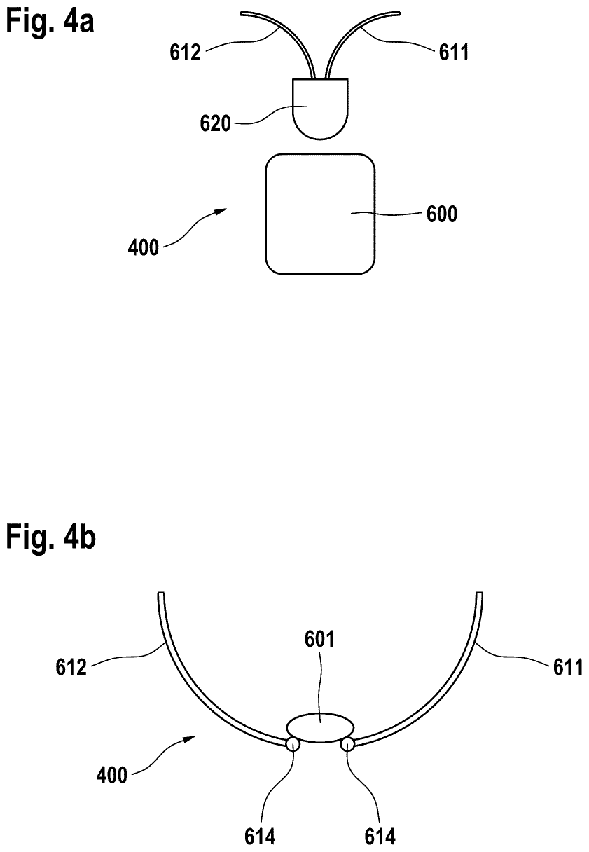

FIG. 4a shows a schematic representation of a fluid-sensitive element with a pressure sensor,

FIG. 4b shows a schematic representation of a fluid-sensitive element with electrical contact,

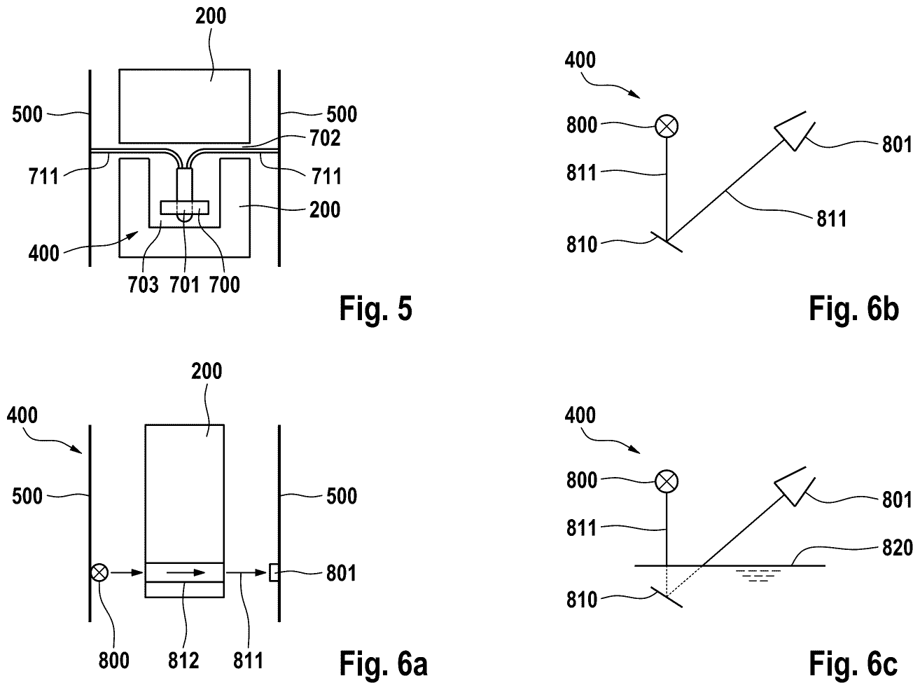

FIG. 5 shows a schematic representation of a sensor element with a float,

FIG. 6a shows a schematic representation of a sensor element with an optical liquid sensor according to a first exemplary embodiment,

FIG. 6b shows a schematic representation of a sensor element with an optical liquid sensor according to a second exemplary embodiment, and

FIG. 6c shows a schematic representation of a sensor element with an optical liquid sensor according to the second exemplary embodiment with fluid.

### DETAILED DESCRIPTION

In the following detailed description of the embodiments, for the sake of clarity, the same reference signs designate substantially identical parts in or on these embodiments. However, for better clarification, the embodiments illustrated in the figures are not always drawn to scale.

FIG. 1 shows a circuit diagram of an example electro-hydraulic braking device 100. The braking device 100 has a hydraulic block 200, wherein an electromotive pressure supply device 202 with a motor position sensor 214, a pressure sequence valve 206, two pressure sensors 212 and an inlet valve 216 and an outlet valve 218 for each wheel brake are arranged as essential components of a brake system in the hydraulic block 200.

The hydraulic block 200 is connected to a brake fluid reservoir 110 and to the hydraulically actuated wheel brakes 208.

The electromotive pressure supply device 202 is hydraulically connected to the wheel brakes 208. The pressure sensor 212 and a normally open inlet valve 216 for each wheel brake 208 are arranged between the pressure sequence valve 206 and the wheel brakes 208. The inlet valves 216 are preferably in the form of analogized solenoid valves for modulating a pressure generated by the pressure supply device 202.

The wheel brakes 208 in turn are connected to the brake fluid reservoir 110 via the outlet valves 218, wherein the outlet valves 218 are in the form of normally closed valves. Finally, the wheel brakes 208 are connected to the brake fluid reservoir 110 on the inlet side.

During normal operation of the braking device 100 illustrated, the pressure sequence valve 206 is open, and so there is a direct hydraulic connection between the pressure supply device 202 and the wheel brakes 208. The hydraulic pressure provided by the pressure supply device 202 on the basis of an actuation signal can then be individually modulated in each case by the inlet valves 216 and the outlet valves 218 for the wheel brakes 208, whereby ABS control functions for example can be implemented. The pressure supply device 202 may be controlled on the basis of a signal from the motor position sensor 214.

FIG. 2a shows a schematic representation of an exemplary braking device 100 with a possible arrangement of a hydraulic block 200 and a container 300 for accommodating an electronic brake control device 311, 321. In this arrangement, the container 300 is arranged substantially below the hydraulic block 200. The container 300 can be flanged to the hydraulic block 200. In this space-saving embodiment, the brake fluid reservoir 110 (not illustrated in this FIG. 2a and in FIG. 2b) can be arranged opposite the container 300 above the hydraulic block 200.

FIG. 2b shows a schematic representation of an exemplary braking device 100 with a further possible arrangement of a hydraulic block 200 and a container 300 for accommodating an electronic brake control device 311, 321. In this exemplary embodiment, two containers 300 are provided and are located substantially on both sides of the hydraulic block 200.

The container 300 is designed as a closed housing in order to protect the electronic brake control devices 311, 321.

These embodiments only show possible arrangement variants of the container 300 and further arrangements are also possible and envisaged.

The container 300 illustrated schematically in FIG. 2a is formed with two partial volumes 312, 322, wherein an electronic brake control device 311, 321 is arranged in each partial volume 312, 322. The two partial volumes 312, 322 are separated from one another by an intermediate wall 301.

The electromotive pressure supply device 202 can be driven, for example, by a brushless electric motor which can be controlled by each of the two electronic brake control devices 311, 321.

Further, two sensor elements 400 that are designed to detect a fluid are arranged in the container 300. In FIGS. 2a and 2b, these sensor elements 400 are only schematically depicted for illustration. The sensor elements 400 are each connected to the associated brake control device 311, 321.

The fluid may generally comprise a liquid medium. This should be understood as meaning, for example, brake fluid, oil, water, coolant, steering fluid or other fluids. It can be seen from FIGS. 2a and 2b that, in the event of a leak in the hydraulic system 200, for example, a leak of the pressure supply device 202 or a valve 206, 216, 218, brake fluid can enter the hydraulic block 200 and from there can enter the container 300 via openings, for example through openings for the electrical contact.

According to one embodiment, the container 300 or the hydraulic block 200 comprises a base 302 with a recess (not illustrated) that defines the lowest point in the mounted position or during operation. The base may also be designed to taper at an angle toward the recess. Compared to a rather flat base, this can ensure that a fluid collects at a defined location in the recess. A fluid infiltrating the container 300 can thus be detected. Nesting or twisting in the base area should be avoided wherever possible, as this could impair the flow of the fluid toward the recess.

The presence of a recess is not mandatory. Of course, it is also possible to design the base 302 to be flat, as shown in FIGS. 2a and 2b, or, for example, to be oblique or inclined.

In one development, at least one bead that is oriented toward the recess may be additionally provided in the base 302. This allows a fluid to be quickly directed to the recess where it can be detected.

In order to protect the electronic brake control device 311, 321 in the container 300, it is favorable if no fluid is present in the container 300, since, in the event of contact between a fluid and the electronic brake control device 311, 321, impairments and/or damage to the electronic brake control device 311, 321 can occur.

The sensor elements 400 are arranged near the base in order to be able to detect a possible fluid quickly. The at least one sensor element 400 is advantageously arranged in the area of the recess or even, if possible due to the installation space, arranged within the recess in order to be able to detect a fluid quickly and reliably.

In the example in FIG. 2a, a sensor element 400 is provided in each partial volume 312, 322.

Instead of a single sensor element 400, which thus represents a discrete measurement point, according to one development, a plurality of sensor elements 400 can also be provided and can be at a distance from one another in the vertical direction. This makes it possible to provide a plurality of discrete measurement points which can detect different filling levels of fluid in the container 300.

The sensor element(s) 400 is/are connected to the electronic brake control device 311, 321 or to the switching unit, with the result that the switching unit or the brake control device 311, 321 can receive signals from the sensor element 400.

As a result of the intermediate wall 301, the braking device 100 can have a redundant design, with the result that, in the event of failure or impairment of one electronic brake control device 311, 321, it is possible to switch to the other electronic brake control device 311, 321.

The electronic brake control device comprises at least one printed circuit board 500, wherein the sensor element 400 is formed on the printed circuit board 500 or as part of the printed circuit board 500. FIG. 3a shows a schematic representation of a section of a printed circuit board 500 with a conductivity sensor 510 of a brake control device 311, 321. The printed circuit board 500 is equipped with a sensor element, labeled in its entirety with the reference sign 400, at a corner of the printed circuit board 500.

The sensor element 400 is arranged on the section 501 of the printed circuit board pointing to the base during operation, which is intended to be indicated by the dashed line 503. The section of the printed circuit board 500 shown therefore points to the base in the mounted position. In the embodiment illustrated, the lower section 501 is free of other electronic or other component parts 502, with the result that the sensor element 400 is the lowest component part of the printed circuit board 500. In this way, an ingress of fluid can already be detected by the sensor element 400 before other component parts 502 can come into contact with ingressing fluid.

According to one development, the printed circuit board 500 may also comprise a projecting area or projection (not illustrated) on the edge pointing to the base during operation. The at least one sensor element 400 may then be placed on this projection. The surface area of the printed circuit board can be used in this way for the required component parts, and layout plans can be adopted without major changes or need not be changed in order to be able to place the sensor element. In one embodiment, the projection is geometrically or structurally adapted to the recess in the base area of the container 300. This makes it possible to arrange the projection with the sensor element 400 at least in sections in the recess.

However, the sensor element 400 may also be formed as a separate component part according to a further embodiment. This allows greater flexibility with respect to the arrangement of the recess and the printed circuit board 500, for example if the printed circuit board 500 is intended to be arranged at a different location than a recess.

In the embodiment illustrated in FIG. 3a, the sensor element 400 is in the form of a conductivity sensor 510. For this purpose, two conductor tracks 511, 512 are arranged on the printed circuit board 500 at a short distance from one another, for example approximately 1 mm. Electrical contact is made with the conductor tracks 511, 512 via contacts 514 and a voltage is applied to said conductor tracks.

In the event of contact with the fluid, an electrical connection can be established between the two conductors 511, 512, which can be detected by the switching unit or the brake control device 311, 321.

In the case of only one sensor element 400 or one discrete measurement point, the switching unit can thus receive a signal or information indicating that a fluid is present at this measurement point and has thus infiltrated the container 300.

In the case of a plurality of sensor elements 400 or a plurality of discrete measurement points, information about the height of the filling level of fluid can also be obtained. In this way, a leakage rate, i.e. an increase in the fluid over time, can also be determined, for instance.

FIG. 3b shows, purely by way of example, a schematic representation of a section of a printed circuit board with two sensor elements 400 which are likewise in the form of conductivity sensors 510 in the example, as shown in FIG. 3a.

It goes without saying that it is also possible and envisaged to arrange more than two sensor elements 400 at different heights, for example three, four or five sensor elements 400.

It also goes without saying that it is also possible to provide other embodiments of sensor elements 400, as explained further below, for example. It is also possible and envisaged to combine different embodiments of sensor elements 400 with each other.

Conductivity sensors 510 as shown in FIGS. 3a and 3b can be implemented in a comparatively simple and cost-effective manner. In addition, they can be very small, which also speaks for their use.

As shown in FIG. 2a, at least one sensor element 400 may be provided in each of the two partial volumes 312, 322. This is due to the fact that the intermediate wall 301 often cannot be designed to be completely fluid-tight, for example as a result of wiring through the intermediate wall 301. This makes it possible to ensure that fluid can be detected in both partial volumes and the corresponding reactions can be triggered.

FIGS. 4a and 4b show further suitable embodiments of sensor elements 400 using the example of a fluid-sensitive element 600. The fluid-sensitive element 600 is designed to change at least one property upon contact with a fluid. In the exemplary embodiments in FIGS. 4a and 4b, this property relates to the volume of the fluid-sensitive element 600.

In this respect, FIG. 4a shows a schematic representation of a fluid-sensitive element 600 with a pressure sensor 620, wherein the fluid-sensitive element 600 is designed to increase its volume upon contact with a fluid. In the example, the fluid-sensitive element 600 comprises a swelling material, for example a hydrophilic polymer material, for example rubber.

Upon contact with the fluid, the fluid-sensitive element 600 expands, which can be detected with the pressure sensor 620. The pressure sensor is connected via electrical conductors 611, 612 to the switching unit or the brake control device 311, 321 in order to give a corresponding signal to the switching unit or the brake control device 311, 321.

FIG. 4b shows a schematic representation of a fluid-sensitive element 600 of a further embodiment with electrical contact. According to this embodiment, the fluid-sensitive element 600 comprises a material which shrinks or even dissolves due to contact with the fluid. The material is electrically conductive and arranged between two electrical conductors or electrical contacts 614. The material can shrink upon contact with the fluid, causing the electrical connection to be interrupted and an appropriate signal to be output. In the example, the fluid-sensitive element 600 comprises polyvinyl alcohol (PVA) which dissolves upon contact with fluid and thereby interrupts an electrical connection.

According to another development of this embodiment, it is also possible to use a hygroscopic material which can absorb fluid from the environment and can thereby change its properties, for example its electrical resistance.

Embodiments with a fluid-sensitive element 600 can be used flexibly, since they can be correspondingly small and are therefore suitable for being arranged, for instance, in a recess or another lowest point of the container 300.

According to a further embodiment, a sensor element 400 comprising a float 700 is provided, wherein the float 700 is movably arranged in the vertical direction. When a certain position is reached or when a predefined position is left, a corresponding electrical signal can be sent to the switching unit, for example by the float 700 triggering a microswitch at a certain position. The at least one float 700 may be arranged in the hydraulic block 200 according to one embodiment.

FIG. 5 shows, by way of example, a schematic representation of such a sensor element 400 with a float 700 which is arranged on a guide 701. The guide 701 allows vertical guidance of the float 700. The float 700 is accommodated in a leakage chamber 703 which represents the recess of the arrangement. For this purpose, holes 702, through which fluid can flow to the recess, are provided in the exemplary embodiment. In the exemplary embodiment, the float 700 and the recess are arranged in a space-saving manner in the hydraulic block 200, but it goes without saying that other arrangements are also possible and conceivable. As soon as fluid flows into the recess, the float 700 rises and can trigger a switch, for example a microswitch, whereupon a corresponding signal can be given via the conductors 711 to the printed circuit boards 500 of the two electronic brake control devices 311, 321.

According to yet another embodiment, a sensor element 400 which is in the form of an optical liquid sensor is provided, comprising an emitter 800 which can emit electromagnetic radiation, and a light sensor 801 which is designed to detect this electromagnetic radiation. The emitter 800 may comprise, for example, a light-emitting diode or a laser source. For example, the light sensor 801 may comprise CMOS or CCD sensors.

FIG. 6a shows a schematic representation of a sensor element 400 with such an optical liquid sensor according to a first exemplary embodiment. In the exemplary embodiment, provision is made for the emitter 800 to emit the electromagnetic radiation directly in the direction of the light sensor 801. The electromagnetic radiation, for example in the visible wavelength range, is depicted in the figure only by way of example with arrows and is labeled with the reference sign 811.

When a fluid infiltrates the space between the emitter 800 and the light sensor 801, the electromagnetic radiation 811 can be attenuated by light scattering, for example. This attenuation can be detected by the light sensor 801 and sent as a corresponding signal to the switching unit.

In the exemplary embodiment, the emitter 800 is arranged on the printed circuit board 500 of the first electronic brake control device 511 and the light sensor 801 is arranged on the printed circuit board 500 of the second electronic brake control device 521, which is a particularly cost-effective design. The electromagnetic radiation 811 is passed through a passage opening 812 through the hydraulic block 200. The emitter 800, light sensor 801 and continuous opening 812 are arranged close to the base.

In a further embodiment of an optical liquid sensor, provision is made for the emitter 800 to direct the electromagnetic radiation 811 in the direction of a reflective element 810, for example a mirror. FIG. 6b shows a schematic representation of such a sensor element with an optical liquid sensor. The reflective element 810 is in the form of a mirror here and is located in the beam path of the emitter 800, but is slightly inclined with respect thereto. The electromagnetic radiation 811 can be reflected thereby and directed to the light sensor 801, where it can be detected.

The reflective element 810 may be arranged in the container 300 at a position at which ingressing fluid can collect. FIG. 6c shows a schematic representation of an optical liquid sensor in the presence of fluid, which is labeled with the reference sign 820. The mirror 810 is covered with fluid 820, with the result that the electromagnetic radiation 811 is incident on the fluid 820. At the surface of the fluid 820, the incident electromagnetic radiation 811 is scattered and/or reflected, with the result that less or no radiation 811 at all reaches the light sensor 801. This deviation can be detected and transmitted as a corresponding signal to the switching unit.

1. A braking device as part of a brake system for a motor vehicle comprising
a container with a cavity,
a hydraulic block with a pressure supply device, and
an electronic brake control device which is configured to control the pressure supply device,
wherein the electronic brake control device is arranged in the container,
wherein at least one sensor element that is designed to detect a fluid is provided, and
wherein the sensor element is arranged in the container or in the hydraulic block.

2. The braking device as claimed in claim 1, wherein one of the container and the hydraulic block comprise a base with a recess that defines the lowest point in the operating state, wherein at least one bead which is oriented toward the recess is provided on the base.

3. The braking device as claimed in claim 1, wherein the sensor element is designed to detect the presence or occurrence of a fluid.

4. The braking device as claimed in claim 1, wherein the hydraulic block comprises valves, which are connected to the pressure supply device.

5. The braking device as claimed in claim 1, wherein the at least one sensor element is arranged near the base in the area of the recess.

6. The braking device as claimed in claim 1, wherein at least two sensor elements are provided and are arranged at a distance from one another in the vertical direction.

7. The braking device as claimed in claim 1, wherein the brake control device comprises at least one printed circuit board, wherein the sensor element is formed as one of on the printed circuit board and as part of the printed circuit board.

8. The braking device as claimed in claim 1, wherein the at least one sensor element is arranged on a section of the printed circuit board pointing to the base during operation, wherein this section of the printed circuit board pointing to the base is preferably free of other electronic or other component parts.

9. The braking device as claimed in claim 7, wherein the printed circuit board comprises a projection on the edge pointing to the base during operation, wherein the at least one sensor element is at least partially arranged on this projection, wherein the projection with the sensor element is arranged at least in sections in the recess protrudes into the recess.

10. The braking device as claimed in claim 7, wherein the at least one sensor element is in the form of a conductivity sensor.

11. The braking device as claimed in claim 1, wherein the at least one sensor element comprises a pressure sensor and a fluid-sensitive element, wherein the fluid-sensitive element comprises a material, wherein the fluid-sensitive element can expand upon contact with fluid.

12. The braking device as claimed in claim 1, wherein the at least one sensor element comprises a fluid-sensitive element, preferably an electrically conductive fluid-sensitive element, with an electrical contact, wherein the fluid-sensitive element can contract or dissolve upon contact with fluid.

13. The braking device as claimed in claim 1, wherein the at least one sensor element comprises a float, wherein the float is movably arranged in the vertical direction, and wherein the float is designed to send an electrical signal to the switching unit upon reaching or leaving a certain position.

14. The braking device as claimed in claim 1, wherein the at least one float is arranged in the hydraulic block.

15. The braking device as claimed in one claim 1, wherein the at least one sensor element is in the form of an optical liquid sensor, comprising an emitter which is configured to emit electromagnetic radiation during operation, and a light sensor which is designed to detect this electromagnetic radiation, and wherein the light sensor is arranged in the beam direction of the emitter.

16. The braking device as claimed in claim 1, wherein the hydraulic block comprises a through-hole, through which the electromagnetic radiation of the light sensor can be guided during operation.

17. The braking device as claimed in claim 1, wherein a reflective element is provided and arranged in the beam path of the emitter on the base of the container or the hydraulic block, in the recess, and can deflect light from the emitter to the light sensor during operation.

18. A method for operating a brake system for a vehicle comprising:
controlling a pressure supply device for a hydraulic block with an electronic brake control device arranged in a container with a cavity, and
detecting a fluid with at least one sensor element arranged in the container or in the hydraulic block.

19. The braking device as claimed in claim 1, wherein the container is of two-part design, wherein an intermediate wall separates a first and a second partial volume from each other, and wherein a first brake control device is arranged in the first partial volume and a second brake control device is arranged in the second partial volume.
